(19) United States
(12) Patent Application Publication
(10) Pub. No.: US 2009/0089365 A1
(43) Pub. Date: Apr. 2, 2009

(54) Web services replica management

(75) Inventors: Laura Serghi, Ottawa (CA); Lyle Strub, Ottawa (CA)

Correspondence Address: KRAMER & AMADO, P.C., 1725 DUKE STREET, SUITE 240, ALEXANDRIA, VA, 22314, US

(73) Assignee: Alcatel Lucent, Paris (FR)

(21) Appl. No.: 11/905,022

(22) Filed: Sep. 27, 2007

(51) Int. Cl. G06F 15/173

(52) U.S. Cl. 709/203; 709/223; 709/238

(57) ABSTRACT

A method of web services replica management and associated web service gateways, the method including one or more of the following: sending a web service request from a client application through a local web service gateway; discovering a plurality of remote web service gateways offering replicas of the requested web service; determining a communication delay between the discovered plurality of remote web service gateways and the local web service gateway; creating a cluster manager in a local web service gateway; creating a cluster for a replica web services composite client application; adding a plurality of replica web services to the cluster; adding at least one policy to the cluster; calculating a community of web service replicas based on the at least one policy, such as a replica selection policy that may include an information policy and a load estimation method; and determining an optimum web service replica among the discovered plurality of remote web service gateways.

### BACKGROUND OF THE INVENTION

1. Field of the Invention

This invention relates generally to the selection of a duplicated service available over the public Internet or over any private network.

2. Description of Related Art

As used herein, the phrase web service replica refers to multiple distinct services that provide equivalent functionality to a user or client application. Replicas often exist within a corporation in order to provide service scalability via load balancing. Replicas sometimes also exist for public services or for business-to-business services within a service marketplace.

Examples of replicas that exist for public services include getting the current time and getting a currency exchange rate. Examples of replicas that exist for business-to-business services within a service marketplace include getting a stock quote. In the context of web service replicas, there exists a need to identifying an optimal replica for use, and for subsequently using the identified optimal web service replica.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for web services replica management, a brief summary of various exemplary embodiments is presented. Some simplifications and omissions may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various exemplary embodiments allow an enterprise to initially discover the location of multiple replicas of a web service and to dynamically select the optimal replica, at runtime, in a geographically distributed network. Multiple web services replicas may be located across a corporation's large extranet network. In such embodiments, the optimal web service replica selection sometimes depends on service access specific requirements such as a load on the network, minimizing costs, and so on. In various exemplary embodiments, when access requirements change, the system automatically adjusts to the a web service replica serving the new requirements.

Various exemplary embodiments allow enterprises to control, sometimes fully control, some or all of their external accesses to web service offerings. In various exemplary embodiments, this is done in a consistent and cost effective manner at both network and service levels.

Business partners in an extranet typically expect web services to be offered in a timely fashion. Various exemplary embodiments allow a web services extranet to decrease web service response time and achieve fault tolerance. Moreover, in embodiments where web service composite clients are employed, various exemplary embodiments further allow an enterprise to create communities of web services replicas for specific sets of remote web services, clustered for the composite access.

Web services technologies and standards are typically intended to facilitate and/or enable an increase in machine-to-machine (M2M) communications. In contrast, current World Wide Web technologies primarily address person-to-machine interactions. In order for M2M communications to scale using web services various exemplary embodiments include service replicas. Correspondingly, in various exemplary embodiments, replica selection occurs dynamically at run time.

One function of various embodiments is to allow enterprises to securely integrate internal applications with business processes at external partner corporations. Thus various embodiments include a Web Services Gateway (WSG), and a Web Services Manager (WSM).

In various embodiments, the WSG is a network node positioned in a corporation's so-called demilitarized zone (DMZ) and processes web service messages in real time in order to facilitate integration with web services at various partner corporations. The DMZ is an area of limited access that exists between fully trusted users and users that are not given any level of trust. In other words, the DMZ exists in many embodiments between an internal firewall and an external firewall.

In various embodiments, the WSM is a network and service management element that is deployed by an enterprise in order to coordinate web service message processing nodes and maintains a central service registry of all web services that are published by the enterprise along with all associated policies. The WSG is designed, in some embodiments, to allow a corporation to automatically locate web services replicas once they become available, within a multi-enterprise extranet environment.

Once web services replicas are located, in various embodiments, the WSG dynamically chooses the correct or optimal web service replica, while the web services traffic passes through the WSG, in order to coordinate load optimization on the remote application servers hosting the web services applications. By choosing the appropriate replica, furthermore, in various embodiments the WSG dynamically adjusts the network load as each application backend server becomes more heavily loaded. At the same time, in various embodiments, the WSG automatically adjusts to a new web service replica, at a different external location. This is believed to assist in minimizing costs, for example.

Moreover, in various embodiments, when web service composite client applications are used within the corporation, the WSG executes an optimal forwarding towards chosen web services replica destinations. Thus, various exemplary embodiments offer at the WSG a functionality that allows creation of clusters of remote web services replicas. In various embodiments, clusters of web service replicas are formed based on grouping them together in accordance with a criterion. Examples of such a criterion (or criteria) include, but are not limited to, minimal total distance to all web services requested by the composite application, and optimal response time back to the composite client.

In other words, in various exemplary embodiments, web service replica selection is executed at a cluster level. Therefore, in various embodiments the selected web services destinations differ when the web services are in a cluster as compared to when the same web services are accessed individually, that is, outside of a cluster. At the WSG, the subset of web services grouping is referred to herein as “a community of web services replicas.” Moreover, in various exemplary embodiments, clusters of communities of replicas are further created and controlled from the WSG.

Various exemplary embodiments allow an enterprise to automatically discover new web services replicas, select at runtime the appropriate web service replica location and dynamically forward traffic at the same time by changing the web service destination on the fly, when network or service conditions are changing. Various exemplary embodiments respond to the needs of a composite client application, by selecting the appropriate service destination(s) to satisfy conditions such as current availability of the web services and minimized expected response time.

Various exemplary embodiments include a framework employed for the web service replica selection. Various exemplary embodiments include a web service replica selection framework extending web service architecture to include a broker component that performs the discovery and selection procedure. In various embodiments the selection procedure is transparent to the web service client requesting the service, and avoids the need for the web service requester to directly interact with the universal description, discovery and integration (UDDI) registry.

Various exemplary embodiments include a framework on the web service client-side application. However, such embodiments often include a deployment model that is very static and specific to local needs, requiring that each time network or service requirements change the web service client application has to be recompiled each time with the new specific criteria. Thus, various exemplary embodiments enable the web service client application to incorporate new criteria when network or service requirements change without being recompiled.

In various exemplary embodiments, web services location and distribution happen in a dynamic manner, in the network, at the WSG, rather than at the endpoint, based on policies that allow location selection and forward/load balance based on a multitude of application level metrics chosen at provisioning time.

### BRIEF DESCRIPTION OF THE DRAWINGS

In order to better understand various exemplary embodiments, reference is made to the accompanying drawings, wherein:

FIG. 1 is a schematic diagram of an exemplary embodiment of a system for web services replica management;

FIG. 2 is a flow chart of a first exemplary embodiment of a method for web services replica management;

FIG. 3 is a schematic diagram of a first exemplary embodiment of a WSG;

FIG. 4 is a schematic diagram of a second exemplary embodiment of a WSG;

FIG. 5 is a flow chart of a second exemplary method of web services replica management; and

FIG. 6 is flow chart of a third exemplary method of web services replica management.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

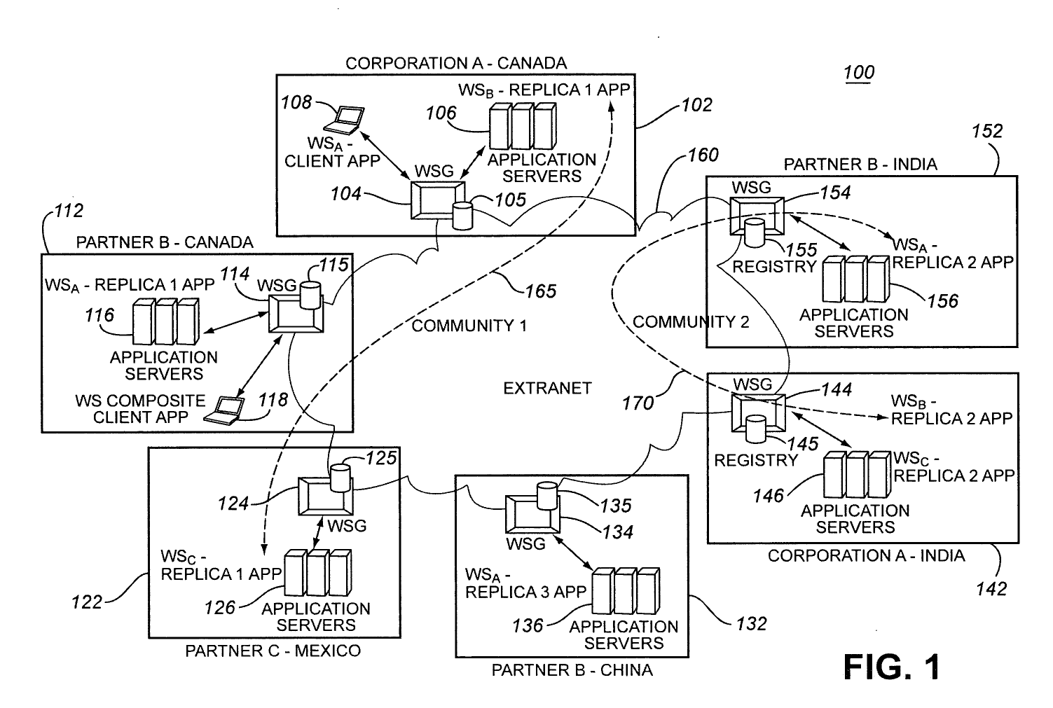

FIG. 1 is a schematic diagram of an exemplary system 100 for web services replica management. The exemplary system 100 includes Corporation A-Canada 102, Partner B-Canada, 112, Partner C-Mexico 122, Partner B-China 132, Partner A-India 142 and Partner B-India 152. An Extranet 160 connects Corporation A-Canada 102, Partner B-Canada 112, Partner C-Mexico 122, Partner B-China 132, Corporation A-India 142 and Partner B-India 152 for the purposes of electronic communications.

Corporation A-Canada 102 and Partner C-Mexico 122 are connected into a community designated as Community1 and indicated by dotted line 165. Similarly, Partner B-India 152 and Corporation A-India 142 are connected in Community2 as indicated by dotted line 170.

Corporation A-Canada 102 includes WSG 104 with Registry 105, Application Servers 106 and Client Application 108. The Application Servers 106 include WS_{B} Replica 1 Application. The Client App 108 includes WS_{A} Client App.

Partner B-Canada 112 includes WSG 114 with Registry 115, Application Servers 116 and Client App 118. The Application Servers 116 include WS_{A}-Replica 1 App. The Client App 118 includes WS Composite Client App.

Partner C-Mexico 122 includes WSG 124 with Registry 125, and Application Servers 126. The Application Servers 126 include WSC-Replica 1 App.

Partner-B China 132 includes WSG 134 with Registry 135, and Application Servers 136. The Application Servers 136 include WS_{A}-Replica 3 App.

Corporation A-India 142 includes WSG 144 and Application Servers 146. Like the other exemplary WSGs depicted, the WSG 144 includes Registry 145. The Application Servers 146 include WS_{B}-Replica 2 App and WS_{C}-Replica 2 App.

Partner B-India 152 includes WSG 154 and Application Servers 156. WSG 154 includes Registry 155. Application Servers 156 include WS_{A}-Replica 2 App.

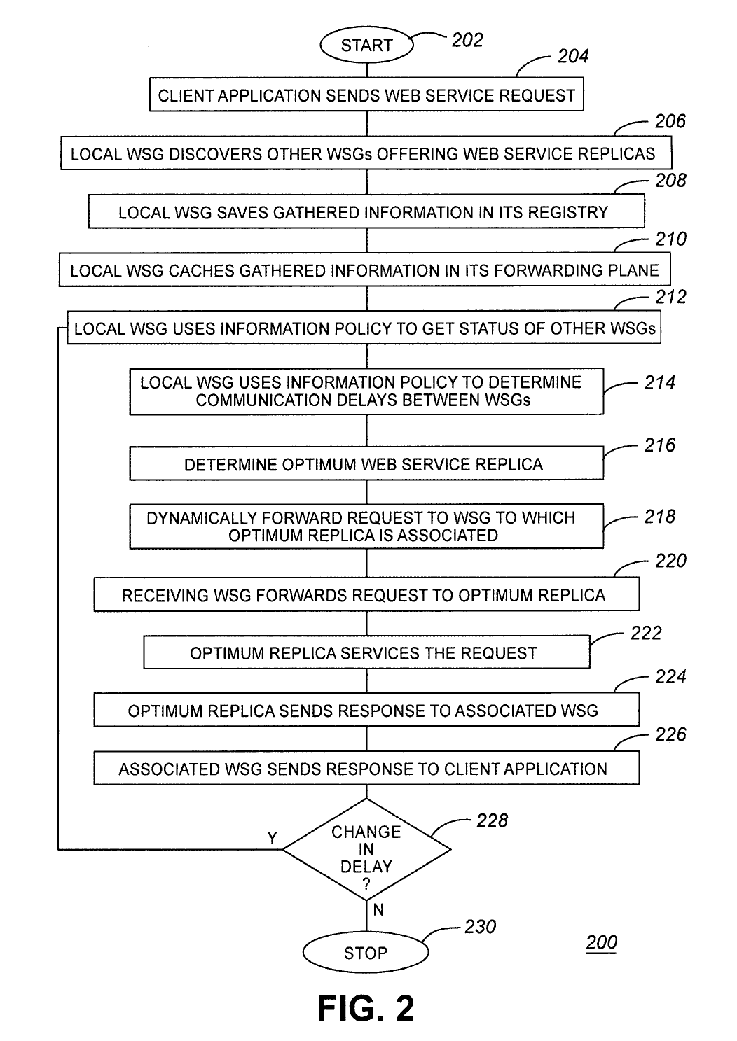

With reference to exemplary system 100, an exemplary implementation of web services replica management exists where Corporation A-Canada 102 desires to consume Web Service A. As indicated in exemplary system 100, three replicas exist for Web Service A at different Extranet locations around the world. All of these replicas are published for consumption at the local registries within the WSGs of each company and partner's enterprises. This structure will be referenced in greater detail below in connection with FIG. 2.

Specifically, still referring to FIG. 1, Partner B-Canada 112 runs the WS Composite Client App 118. As part of the Composite Client App 118, requests are initiated for two remote web service applications. These remote web service applications are indicated as WS_{B}, and WS_{C}. According to exemplary system 100, two replicas are available for WS_{B}, and two replicas are available for WS_{C}.

The two available replicas for WS_{B} in system 100 are WS_{B}-Replica 1 and WS_{B}-Replica 2. The two available replicas for WS_{C} in system 100 are WS_{C}-Replica 1 and WS_{C}-Replica 2. Accordingly, Community1 165 is represented as Community1 {WS_{B} Replica 1, WS_{C} Replica 1}. Likewise, Community2 170 is represented as Community2 {WS_{B} Replica 2, WS_{C} Replica 2}.

Although the WS_{B}-Replica 1 and WS_{C}-Replica 1 applications are geographically closer to the Composite Client Application 118, the broker at WSG 114, the local WSG, may, in various exemplary embodiments, select the cluster of WS_{B} and WS_{C} available from Corporation A-India 142 if other criteria related to the selection of replica applications unrelated to geographic location cause Community2 170 to be determined as optimal.

In various exemplary embodiments, an algorithm dynamically selects and groups together the selected replica applications in accordance with predetermined selection policies. In various exemplary embodiments, the predetermined selection policies are defined and created at the WS cluster level. This will be described in greater detail below.

FIG. 2 is a flow chart of a first exemplary method 200 of web services replica management. The method 200 starts at step 202 and continues to step 204.

In step 204, the client application sends a web service request. Applying step 204 to the specific example described above in connection with exemplary system 100, the WS_{A} Client Application from Corporation A-Canada 102, sends a web service request to a broker in the local WSG 104. Hereinafter, the general steps described in connection with exemplary method 200 will be described more specifically in connection with the example discussed above regarding exemplary system 100.

Following step 204, the method 200 proceeds to step 206. In step 206, the local WSG 104 discovers all of the addresses (URI) of the WSGs offering the WS_{A} service replicas. Once these addresses are discovered in step 206, the method 200 proceeds to step 208.

In step 208, the local WSG 104 saves the gathered information in its registry 105. The method 200 then proceeds to step 210. In step 210, the local WSG 104 caches the information gathered in step 208 in a forwarding plane of the local WSG 104.

Following step 210, the method 200 proceeds to step 212. In step 212, the local WSG 104 uses an information policy to get a status of other WSGs. Additional information regarding exemplary embodiments of an information policy are discussed further below.

Following step 212, the method 200 proceeds to step 214. In step 214, the local WSG 104 uses the information policy to determine communication delays between each WSG in question. Step 214 will also be described in greater detail below.

Following step 214, the method 200 proceeds to step 216. In step 216, a determination is made which web service replica is the optimum web service replica to use. Using again the specific example of exemplary system 100, the determined optimum WS_{A} is that associated with Partner B-India 152.

Following step 216, the method 200 proceeds to step 218. In step 218, the incoming WS request is dynamically forwarded to the WGS with which the web service replica determined in step 216 is associated.

Following step 218, the method 200 proceeds to step 220. In step 220, the WSG that receives the request forwarded in step 218 further forwards that request to the optimum replica determined in step 216.

Following step 220, in step 222, the optimum replica determined in step 216 services the request that it received from the receiving WSG in step 220. Next, the optimum replica sends a response to the associated WSG in step 224.

Following step 224, the exemplary method 200 proceeds to step 226. In step 226, the WSG associated with the optimum web service replica determined in step 216 sends the response to the client application that sent the initial request in step 204.

Following step 226, the exemplary method 200 proceeds to step 228. Regarding step 228, it is believed that a typical communication system regularly has changes in a variety of components that can affect the communication delay that exists between any two WSGs and the communication system. Accordingly, in step 228, an evaluation is made whether any change has occurred in the communication delay between the optimum web service replica determined in step 216 and the client application that sent the original web service request in step 204.

If a determination is made in step 228 that no change has occurred in the communication delay between the optimum web service replica and the client application, then the exemplary method 200 proceeds to step 230 where the method 200 stops. Conversely, if a determination is made in step 228 that a change in the communication delay between the optimum web service replica and the client application has occurred, then the exemplary method 200 returns to step 212.

Subsequently, in step 212, the information policy at the local WSG 104 is then applied and enforced anew. The applicable algorithm calculates anew an optimal WSG destination that satisfies the applicable requirements.

For example, in the first instance of step 216, WS_{A}-Replica 2 App in Application Servers 156, associated with Partner B-India 152, is determined to be the optimum web service replica. Subsequently, after a change in the delay identified in step 228, the method 200 returns to step 212. Eventually associated WS_{A}-Replica 3 App of Application Servers 136, associated with Partner B-China 132, is determined to be a new optimum Web Service Replica when the method 200 returns to step 216. Accordingly, the web service request received from the client application in step 204 subsequent to the determination of a new WSG destination that satisfies the requirements are forwarded in run time, in various exemplary embodiments, to the new WS_{A} replica application, WS_{A}-Replica 3 App of Application Servers 136 in the specific example used herein.

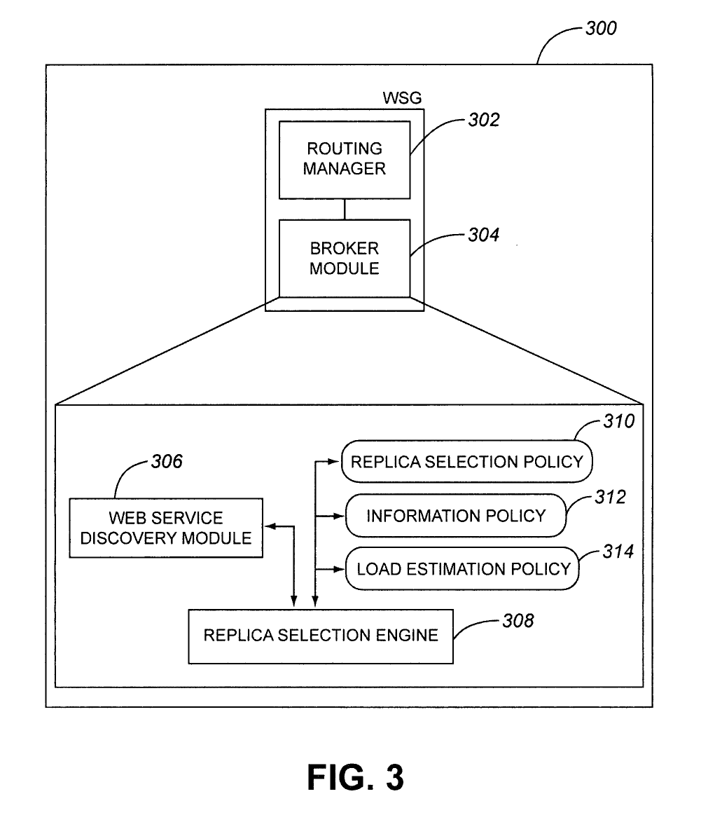

FIG. 3 is a schematic diagram of a first exemplary embodiment of a WSG 300. Exemplary WSG 300 corresponds to, for example, any of the WSGs depicted in exemplary system 100. WSG 300 includes a routing manager 302 and a broker module 304. The broker module 304 includes a Web Service Discovery Module 306, a Replica Selection Engine 308, a Replica Selection Policy 310, an Information Policy 312, and a Load Estimation Policy 314.

The broker module or broker component 304 is a software module residing within the WSG 300. It should be apparent that various steps described above in connection with exemplary method 200 are performed by various of the components residing within the exemplary WSG 300.

For example, in various exemplary embodiments, the steps of discovering web service replicas and selecting optimal web service replicas are procedures performed in the broker module 304. In various exemplary embodiments, the procedure for selecting an optimal web service replica in step 216 of exemplary method 200 is a transparent procedure to the web service client requesting the service, WS_{A} Client App 108. Accordingly, various exemplary embodiments eliminate a need for the web service requestor to directly interact with the UDDI registry.

In various exemplary embodiments, as described above in connection with FIG. 2, the selection of an optimal Web Service Replica in step 216 is determined based on policies that can be configured. The Replica Selection Policy 310, Information Policy 312 and Load Estimation Policy 314 are examples of such policies implemented in WSG 300. In various exemplary embodiments, the Replica Selection Policy 310, Information Policy 312 and Load Estimation Policy 314 can be easily altered in the WSG 300 and easily added to the WSG 300, if not already present in WSG 300. This will be discussed in greater detail below.

In various exemplary embodiments, the information policy 312 includes software implementing various method steps described herein to obtain load information of web service providers and to estimate a communication delay in links between the respective WSGs. In various exemplary embodiments, the load estimation policy 314 is used to estimate the current state of the WS providers and the links between the respective WSGs.

In various exemplary embodiments, the web service discovery module 306 is used to cache additional functionalities that can be added in the broker module 304 to minimize the number of requests to the UDDI registry. In various exemplary embodiments, upon receiving a web service request, the broker module 304 sends a discovery request to the UDDI registry. The UDDI registry then returns to the broker module 304 the address or addresses of the WSGs at all providers of a desired web service. This information is then used by the broker module 304 to determine which WS providers to poll. Accordingly, in various exemplary embodiments, the replica selection engine 308 determines at run time which replica to select among the available replicas existing in the registry.

It should be noted that, in various exemplary embodiments, the replica selection policy 310 represents a plurality of replica selection policies. The replica selection policies are used in different environments. For example, in various exemplary embodiments, replica selection is based on the geographical location of a WS provider. In various exemplary embodiments, the replica selection is based on achieving a particular performance objective.

An example of the foregoing is illustrated in equation (1). The objective function of equation (1) is to minimize the following utility function.

U=(a×WSPload)+(b×CommDelay) (1)

where a is the weight associated with the load of the WS provider (WSPload), and b is the weight associated with the communication delay, CommDelay being a communication delay between the WSG and the WS provider. The replica that optimizes the utility function (U) is selected for satisfying the request of the WS client.

Methods for computing WSPload are discussed below. The features of plug-in components for the broker module 304 used in the replica selection policy 310 are also described hereinafter.

Regarding the information policy 312, the work load of a WS provider is calculated, in various exemplary embodiments, using equation (2).

WSPload=(LQ×ŝ) (2)

where LQ is the queue length of the WS provider and ŝ is the average service time for a web service request. In various exemplary embodiments, the foregoing values are obtained by polling the WSGs at the provider site. The communication delays to the WSGs are calculated, in various exemplary embodiments, as round trip communication times.

In various exemplary embodiments, each broker module 304 in the corresponding WSGs receives the measured values of the communication delay. In various exemplary embodiments, the respective broker modules 304 use these values to recalculate the utility function (U) for each particular iteration of the process.

Regarding the load estimation policy 314, in various exemplary embodiments, in order to reduce wasted time waiting for the work load information and the communication delay, an exponential average of the utility function (U) is implemented. Equation (3) shows one example of how to predict the utility function (U) of an nth iteration based on the two previously computed utility functions (U).

EU(n)=p×U(n−1)+(1−p)×U(n−2) (3)

where EU(n) is the estimate for the utility function for the nth iteration, U(n-i) (i=1,2) is the utility function computed using equation (1) in the (n-i)th iteration and p(p≦1) reflects the weight given to the most computed utility function.

Regarding the replica selection policy 310, in various exemplary embodiments, the WS provider that gives rise to the least EU(n) is chosen. This selection is based on the communication delay between the WSGs and the WS provider's workload. If multiple WS providers have equal EU(n) values, then, in various exemplary embodiments, a WS provider is chosen randomly.

The foregoing corresponds to a first approach used in web services replica management. This first approach uses a “replica location discovery and selection broker” framework for discovering and selecting new web service replicas, at multiple locations in a multi-enterprise extranet architecture. In various exemplary embodiments, the framework selects an appropriate web service replica based on dynamic factors, including, but not necessarily limited to, the service provider workload, and the communication delay. These metrics are analyzed at the WSG when choosing the forwarding path towards a specific web service.

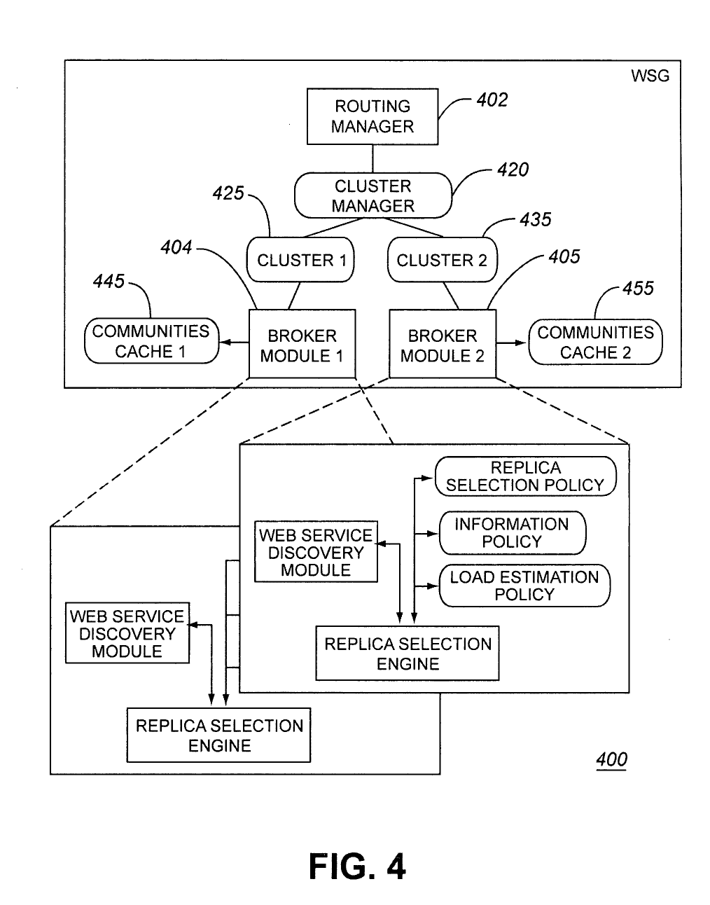

A second approach to web services management is related to the use of communities of web service replicas to satisfy the needs of composite client applications. According to the second approach, clusters of communities are used when multiple composite applications work in tandem. Thus, in various exemplary embodiments, selection policies and selection algorithms are defined at the community level. This is shown in connection with FIG. 4.

FIG. 4 is a schematic diagram of a second exemplary embodiment of a WSG 400. Generally speaking, a WSG 400 corresponds to the second approach to web services replica management, where each community of replicas has its own replica selection broker. Both approaches use the WSG product to host a “replica location discovery and selection broker” and, in various exemplary embodiments, show the creation, configuration and management of replica communities and clusters of communities, respectively.

Exemplary WSG 400 includes a routing manager 402, a first broker module 404 and a second broker module 405. The broker module 404 and the broker module 405 each include a web service discovery module, a replica selection engine, a replica selection policy, an information policy, and a load estimation policy that correspond to those described above in connection with broker module 304.

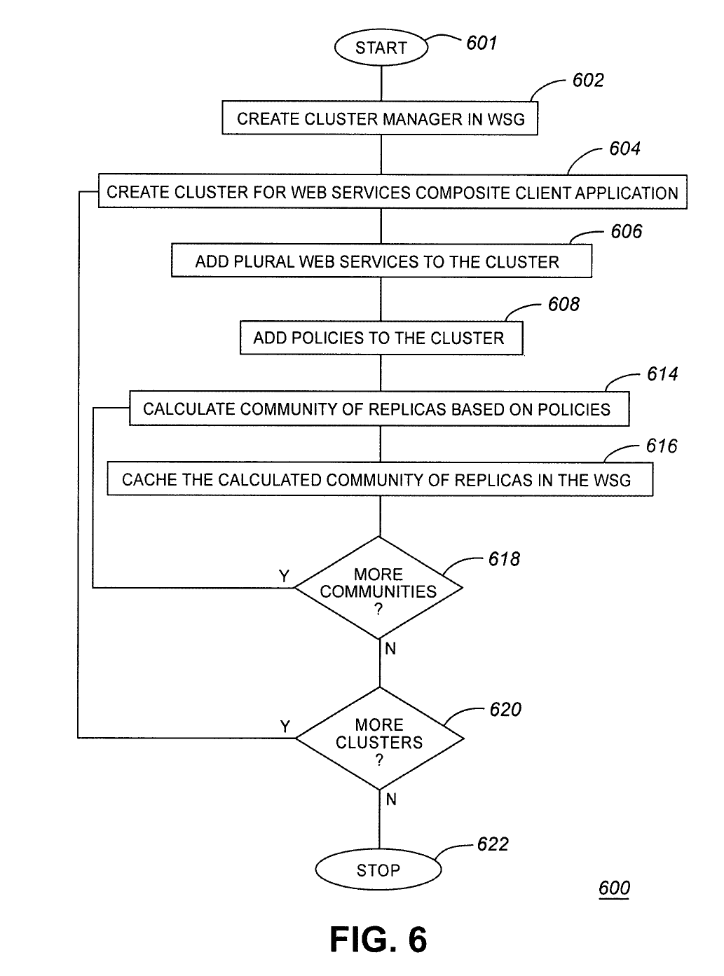

Exemplary WSG 400 further includes a cluster manager 420 containing a first cluster 425 and a second cluster 435. Broker module 404 corresponds to cluster 425 and broker module 405 corresponds to cluster 435. Broker module 404 deals with a first communities cache 445 and broker module 405 deals with a second communities cache 455. The use of the structure described in connection with exemplary WSG 400 is discussed further below in connection with FIG. 6.

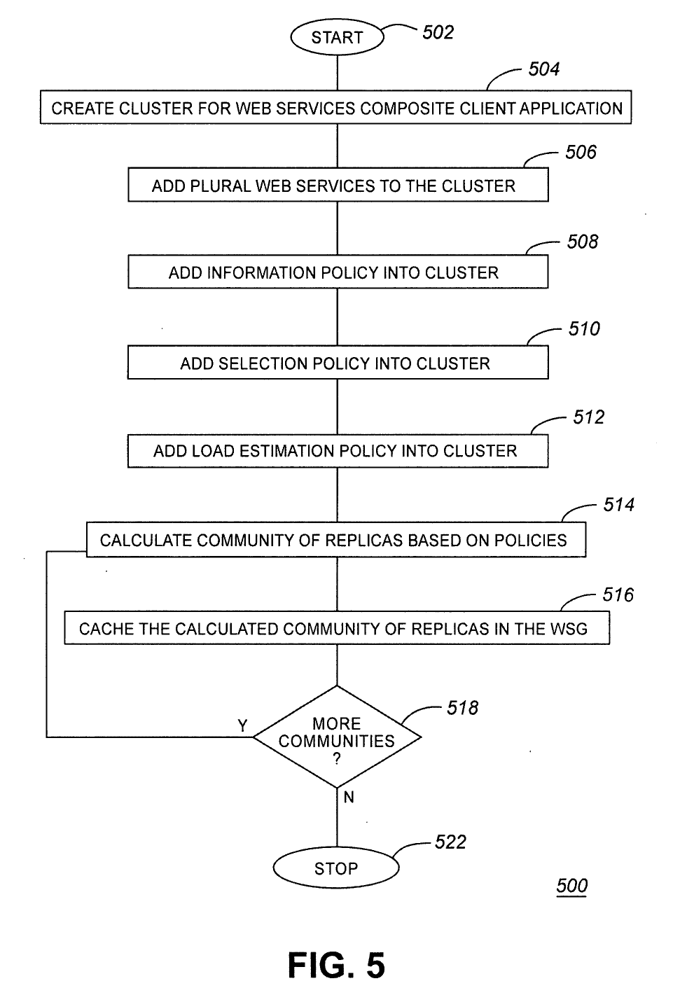

FIG. 5 is a flow chart of a second exemplary method 500 of web services replica management. Again with reference to exemplary system 100, in order to provide specific detail of general concepts, the following are steps that the administrator of Partner B-Canada 112 follows, in various exemplary embodiments, to provision multiple communities of web service replicas that satisfy the needs of the composite client application 118.

Generally speaking, separate clusters of web services are created based on known requirements from the WS composite client application 118. In various exemplary embodiments, all selection policies are defined at the cluster level.

Thus, exemplary method 500 starts in step 502 and continues to step 504. In step 504, a cluster is created for the web services composite client application 118. This cluster is represented in connection with exemplary WSG 400 as cluster 425.

Next, exemplary method 500 proceeds to step 506 where a plurality of web services are added to the cluster 425. With specific reference to system 100, this is represented as add {WS_{B}, WS_{C}} to Cluster1 (the first cluster) 425.

Following step 506, the method 500 proceeds to step 508. In step 508, the information policy, corresponding to information policy 312, is added to cluster 425.

Next, the method 500 proceeds to step 510. In step 510, a selection policy is added into cluster 425. The selection policy in step 510 corresponds to selection policy 310.

The method 500 then proceeds to step 512. In step 512, a load estimation policy is added into the cluster 425. The load estimation policy added in step 512 corresponds to the load estimation policy 314.

Each cluster, such as cluster 425 and cluster 435, has a replica selection broker. These are represented by broker module 404 and broker module 405. In various exemplary embodiments, at run time, communities are calculated and cached in the WSG based on the policies described herein. Implementing these steps in connection with the system 100 results in, Community1 {WS_{B} Replica 1, WS_{C} Replica 1} and Community2 {WS_{B} Replica 2, WS_{C} Replica 2}.

Thus, following step 512, exemplary method 500 proceeds to step 514. In step 514 a community of replicas is calculated based on the policies in steps 508, 510, 512.

Following step 514, exemplary method 500 proceeds to step 516. In step 516, the calculated community of replicas is cached in the WSG. Following step 516, exemplary method 500 proceeds to step 518.

The algorithm implementing exemplary method 500, in various exemplary embodiments, then calculates and generates multiple community solutions for each cluster entity. Thus, in step 518, an evaluation is performed whether more communities are desired. In embodiments where multiple community solutions are to be generated for each cluster entity, the method 500 then returns to step 514. When the community created in steps 514 and 516 is the last community that needs to be created for the cluster, then the method 500 proceeds to step 522 where the method 500 stops.

FIG. 6 is a flow chart of a third exemplary method 600 of web services replica management. Exemplary method 600 corresponds to various exemplary embodiments where, at the cluster management level, multiple clusters of web services and communities of replicas work in tandem where multiple composite client applications also work in tandem. In such embodiments, the cluster manager links together the multiple clusters. Thus, clusters of clusters are defined and provisioned in various exemplary embodiments.

Accordingly, exemplary method 600 starts in step 601 and proceeds to step 602. In step 602, a cluster manager 420 is created in the WSG 400. The method 600 then proceeds to step 604.

Steps 604 and 606 correspond to step 504 and 506, described above in connection with exemplary method 500. The method 600 then proceeds to step 608. Step 608 corresponds to steps 508, 510, 512, described above in connection with exemplary method 500. The method 600 then proceeds to step 614. Steps 614, 616, 618 correspond to steps 514, 516, 518, described above in connection with exemplary method 500.

When no more communities are desired for a particular cluster in step 618, the method 600 proceeds to step 620. In step 620, an evaluation is made whether more clusters are desired. In embodiments desiring a plurality of clusters (or more in an existing plurality of clusters), the method 600 then returns to step 604. In embodiments where no more clusters are desired, the method 600 then proceeds to step 622 where the method 600 stops. Accordingly, in various exemplary embodiments, cluster 425 is created, cluster 435 is created, and, still further clusters can be created.

Based on the foregoing, in various exemplary embodiments, the WSG automatically discovers new web service replicas, selects at one time the appropriate web service replica location, and forwards traffic towards the selected destination. In various exemplary embodiments, service selection criteria are altered dynamically as network or service conditions change. Accordingly, in various exemplary embodiments, web services location, selection and management occur in a dynamic manner in the network. For composite client applications, in various exemplary embodiments, the WSG manages the discovery and selection of a service destination to satisfy conditions, such as, for example, reaching web services and responding back to a composite client in a timely and distance effective manner.

It is believed that the subject matter described herein is preferable in applications where the cost of using non-optimal services outweighs the additional processing overhead. Thus, it is anticipated that the subject matter described herein is a solution applicable to growing service networks of large scale.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of web services replica management, comprising:
sending a web service request from a client application through a local web service gateway;
discovering a plurality of remote web service gateways offering replicas of the requested web service;
using an information policy to determine a communication delay between the discovered plurality of remote web service gateways and the local web service gateway; and
determining an optimum web service replica among the discovered plurality of remote web service gateways.

2. A method of web services replica management, according to claim 1, further comprising saving gathered information about the discovered plurality of remote web service gateways in a registry of the local web service gateway.

3. The method of web services replica management, according to claim 1, further comprising caching gathered information about the discovered plurality of remote web service gateways in a forwarding plane of the local web service gateway.

4. The method of web services replica management, according to claim 1, further comprising using an information policy to get a status of the discovered plurality of remote web service gateways.

5. The method of web services replica management, according to claim 1, further comprising:
dynamically forwarding the web service request to a one of the discovered plurality of remote web service gateways with which the optimum web service replica is associated;
forwarding the web service request from the one of the discovered plurality of remote web service gateways with which the optimum web service replica is associated to the optimum web service replica of the requested web service;
servicing the web service request at the optimum web service replica of the requested web service;
sending a response to the sent web service request from the optimum web service replica to the one of the discovered plurality of remote web service gateways with which the optimum web service replica is associated; and
sending the response to the sent web service request from the one of the discovered plurality of remote web service gateways with which the optimum web service replica is associated to the client application.

6. A web service gateway for web services replica management, comprising:
a routing manger that manages a routing of a web services request; and
a broker module including a web service discovery module that discovers replica web services of the requested web service, a replica selection engine that selects an optimum replica web service from among the discovered replica web services, and at least one policy used by the replica selection engine to select the optimum replica web service.

7. The web service gateway for web services replica management, according to claim 6, wherein the at least one policy is selected from a plurality of stored replica selection policies.

8. The web service gateway for web services replica management, according to claim 6, wherein a replica selection policy includes an information policy and a load estimation method.

9. A web service gateway for a web services replica management, comprising:
a routing manager for managing routing of a web service request;
a cluster manager for managing a cluster of replica web services for the requested web service;
a first cluster of replica web services for the requested web service;
a first cache of communities of web service replicas of the requested web service; and
a first broker module including a web service discovery module for discovering web service replicas of the requested web service, a replica selection engine for selecting an optimum web service replica among the discovered web service replicas based on at least one policy.

10. The web service gateway for web services replica management, according to claim 9, wherein the at least one policy is selected from a plurality of stored replica selection policies.

11. The web service gateway for web services replica management, according to claim 9, wherein a replica selection policy includes an information policy and a load estimation method.

12. The web service gateway for web services replica management, according to claim 9, further comprising:
a second cluster of replica web services for the web services request;
a second cache of communities of web service replicas of the requested web services; and
a second broker module including a web service discovery module for discovering web service replicas of the requested web service, a replica selection engine for selecting an optimum web service replica among the discovered web service replicas based on at least one policy.

13. The web service gateway for web services replica management, according to claim 9, wherein the at least one policy is selected from a plurality of stored replica selection policies.

14. The web service gateway for web services replica management, according to claim 9, wherein a replica selection policy includes an information policy and a load estimation method.

15. A method of web services replica management, comprising:
creating a cluster for a web services composite client application;
adding a plurality of web services to the cluster;
adding at least one policy to the cluster; and
calculating a community of web service replicas based on the at least one policy.

16. The method of web services replica management, according to claim 15, wherein the at least one policy is selected from a plurality of stored replica selection policies.

17. The method of web services replica management, according to claim 15, wherein a replica selection policy includes an information policy and a load estimation method.

18. The method of web services replica management, according to claim 15, further comprising caching the calculated community of web service replicas in a web service gateway local to the web services composite client application.

19. The method of web services replica management, according to claim 15, further comprising:
determining that an additional community of web service replicas is desired;
calculating the additional community of web service replicas based on the at least one policy; and
caching the calculated additional community of web service replicas.

20. A method of web services replica management, comprising:
creating a cluster manager in a local web service gateway;
creating a cluster for a replica web services composite client application;
adding a plurality of replica web services to the cluster;
adding at least one policy to the cluster; and
calculating a community of web service replicas based on the at least one policy.

21. The method of web services replica management, according to claim 20, wherein the at least one policy is selected from a plurality of stored replica selection policies.

22. The method of web services replica management, according to claim 20, wherein a replica selection policy includes an information policy and a load estimation method.

23. The method of web services replica management, according to claim 20, further comprising caching the calculated community of web service replicas in the local web services gateway.

24. The method of web services replica management, according to claim 20, further comprising:
determining that an additional community is desired;
calculating a community of web service replicas for the additional community based on the at least one policy; and
caching the calculated community of additional web service replicas for the additional community in the local web services gateway.

25. The method of web services replica management, according to claim 24, further comprising:
determining that an additional cluster is desired;
creating the additional cluster for the web services replica composite client application;
adding a plurality of web services to the additional cluster;
adding the at least one policy to the additional cluster; and
calculating a community of web service replicas for the additional cluster based on the at least one policy.
